(19) United States
(12) Patent Application Publication
(10) Pub. No.: US 2022/0073047 A1
(43) Pub. Date: Mar. 10, 2022

(54) VENTILATION CAP ON A SOLENOID VALVE IN COMPRESSED-AIR INSTALLATIONS, FOR EXAMPLE FOR VEHICLES

(71) Applicant: ZF CV Systems Hannover GmbH, Hannover (DE)

(72) Inventors: Marco Seeger, Langenhagen (DE); Johannes Albrecht, Burgwedel (DE)

(21) Appl. No.: 17/424,508

(22) PCT Filed: Jan. 14, 2020
(86) PCT No.: PCT/EP2020/050747

§ 371 Date: Jul. 21, 2021

(30) Foreign Application Priority Data
Jan. 23, 2019 (DE) 10 2019 101 556.1

(51) Int. Cl. B60T 17/00; F16K 31/06; F16K 47/08

(52) U.S. Cl. CPC B60T 17/008; F16K 47/08; F16K 31/0627

(57) ABSTRACT

A venting cap for a solenoid valve for compressed-air systems includes a carrier element configured to be arranged on an outlet tube of the solenoid valve and a sealing element arranged on the carrier element. The sealing element is in the form of a cap which engages radially and axially over the carrier element and which has a coaxially extending circular rim. The circular rim has on its inner side, adjacent to a free axial end, at least one receiver for at least one radially outwardly projecting snap-in contour of a geometrically complementary form on the carrier element. The carrier element has a coaxially arranged hollow-cylindrical extension, which is configured to be fastened to the axial end of the outlet tube. The carrier element has a coaxial venting path connected to an exit opening via a labyrinthine sealing structure.

### CROSS-REFERENCE TO PRIOR APPLICATIONS

This application is a U.S. National Phase application under 35 U.S.C. § 371 of International Application No. PCT/EP2020/050747, filed on Jan. 14, 2020, and claims benefit to German Patent Application No. DE 10 2019 101 556.1, filed on Jan. 23, 2019. The International Application was published in German on Jul. 30, 2020, as WO 2020/151990 A1 under PCT Article 21(2).

### FIELD

The present disclosure relates to a venting cap on a solenoid valve in compressed-air systems, for example for vehicles, having a sealing element which is arranged on a carrier element, wherein the carrier element is arranged on an axial end of an outlet tube of the solenoid valve, and the sealing element is arranged in the region of the axial end of the outlet tube.

### BACKGROUND

A solenoid valve of said type has been disclosed under the designation CVM 472 172 001 in a product description of the applicant. Said solenoid valve is a 3/2-way solenoid valve which admits and vents air. A supply line coming from an air container is connected to a connection, and a magnet armature in the form of a valve body keeps an inlet closed by way of the force of a compression spring. When current is fed to a magnet coil, the armature is moved upward, an outlet is closed and the inlet is opened. The supply air then flows from the inlet connection to the outlet connection and ventilates a working line. After the feeding of current to the magnet coil is interrupted, the compression spring moves the armature back into its initial position. In the process, the inlet is closed and the outlet is opened, and the working line is vented via a space and a venting cap. A diaphragm valve composed of an elastomer material is arranged in the venting cap and is intended to prevent ingress of moisture and spray water into the solenoid valve.

The venting cap may be surrounded by a noise damper, such as is described in DE 10 2009 029 968 A1 of the applicant. A damping means is arranged within the noise damper housing and may comprise a damping material, for example a nonwoven damping fabric or a knitted damping fabric, which is arranged in a wound manner. The solenoid valve CVM 472 172 001 has proven to be successful in operation, but can still be improved with regard to the venting speed, the generation of noise and permanent sealing against ingress of water into the solenoid valve, without the intended service life of the solenoid valve being adversely affected as a consequence.

### SUMMARY

In an embodiment, the present disclosure provides a venting cap for a solenoid valve for compressed-air systems. The venting cap includes a carrier element configured to be arranged on an axial end of an outlet tube of the solenoid valve, and a sealing element arranged on the carrier element in a region of the axial end of the outlet tube. The sealing element is in the form of a cap which engages radially and axially over the carrier element and which has a coaxially extending circular rim. The circular rim has on its inner side, adjacent to a free axial end, at least one receiver for at least one radially outwardly projecting snap-in contour of a geometrically complementary form on the carrier element. The carrier element has a coaxially arranged hollow-cylindrical extension, which is configured to be fastened to the axial end of the outlet tube. The carrier element has, centrally, a coaxial venting path connected in terms of flow to at least one exit opening via a labyrinthine sealing structure.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows an axial sectional view of a generic solenoid valve with a venting cap fitted thereon,

FIG. 2 shows an axial section through the venting cap as per FIG. 1, which has a cap-shaped sealing element fitted on a carrier element, in a first embodiment,

FIG. 3 shows an isometric illustration of the carrier element as per FIG. 2 obliquely from above,

FIG. 4 shows a side view of the carrier element, and

FIG. 5 shows an axial section through the venting cap as per FIG. 1, which has a cap-shaped sealing element fitted on a carrier element, in a second embodiment.

### DETAILED DESCRIPTION

The disclosure presents a venting cap for a solenoid valve in compressed-air systems, in particular for vehicles, which makes possible rapid venting with minimum generation of noise, and at the same time ensures good sealing against ingress of water into the solenoid valve, has a long service life without premature material fatigue and can be produced inexpensively.

Accordingly, the disclosure relates to a venting cap on a solenoid valve in compressed-air systems, for example for vehicles, having a sealing element which is arranged on a carrier element, wherein the carrier element is arranged on an axial end of an outlet tube of the solenoid valve, and the sealing element is arranged in the region of the axial end of the outlet tube.

It is provided for said venting cap that the sealing element is in the form of a cap which engages radially and axially over the carrier element and which has a coaxially extending circular rim, that the rim has on its inner side, adjacent to its free axial end, at least one receiving means for at least one radially outwardly projecting snap-in contour of geometrically complementary form on the carrier element, that the carrier element has a coaxially arranged hollow-cylindrical extension, that said coaxial extension can be fastened to the axial end of the outlet tube, and that the carrier element has, centrally, a coaxial venting path which is connected in terms of flow to at least one exit opening via a labyrinthine sealing structure.

The sealing element and the carrier element can be produced inexpensively from a plastic material in an injection-molding process, can be joined together in a simple manner and can be fastened to the outlet tube of the solenoid valve. Good sealing against ingress of water, in particular spray water, and good noise damping can be achieved in that structures are formed on that side of the base of the sealing element which faces toward the carrier element and on the top side, facing toward said base, of the carrier element and form the labyrinthine sealing structure in a manner interacting with one another.

For the joining-together of the sealing element with the carrier element, it is advantageously possible for at least two, preferably four or six, diametrically opposite receiving means for at least two, preferably four or six, geometrically complementary, radially projecting snap-in contours on the carrier element to be formed in the inner side of the rim. In this way, the sealing element and the carrier element can be latched to one another by being simply plugged together.

The positioning of the sealing element in relation to the carrier element when joined together can be improved if radially projecting centering projections for the rim of the sealing element are formed on the outer circumference of the carrier element between in each case two directly adjacent snap-in contours.

It may furthermore be provided that the labyrinthine sealing structure of the venting cap is formed by a central axial projection and at least one concentric annular projection on that side of the base of the sealing element which faces toward the carrier element and, on the top side of the carrier element, by at least one concentric annular projection on the carrier element.

It may also be provided that undulating structures are formed between the projections on the base of the sealing element and the projections on the top side of the carrier element, which undulating structures form the labyrinth of the labyrinthine sealing structure.

Said undulating structures are be provided structurally by the stated radial projections and the free spaces between the projections on the base of the sealing element and the projections on the top side of the carrier element, or said free spaces can be opened by the compressed air to be vented.

Quick venting by means of the solenoid valve according to the invention with low production of noise can also be achieved in that the at least one exit opening for the compressed air to be vented are arranged at the carrier element between the radially projecting snap-in contours and/or between the radially projecting centering projections.

Alternatively, it may be provided that the at least one exit opening for the compressed air to be vented is formed at the coaxially extending rim of the cap-shaped sealing element.

A further alternative provides that the at least one exit opening for the compressed air to be vented is formed radially at the outside at the base of the cap-shaped sealing element.

The venting cap can be used on a solenoid valve in connection with compressed-air braking systems, manual-transmission actuation devices and/or air-spring and axle-lifting systems for vehicles.

A further solution consists of a motor vehicle having a venting cap as described herein in a compressed-air system in the form of a compressed-air braking system, a manual-transmission actuation device and/or an air-spring and axle-lifting system.

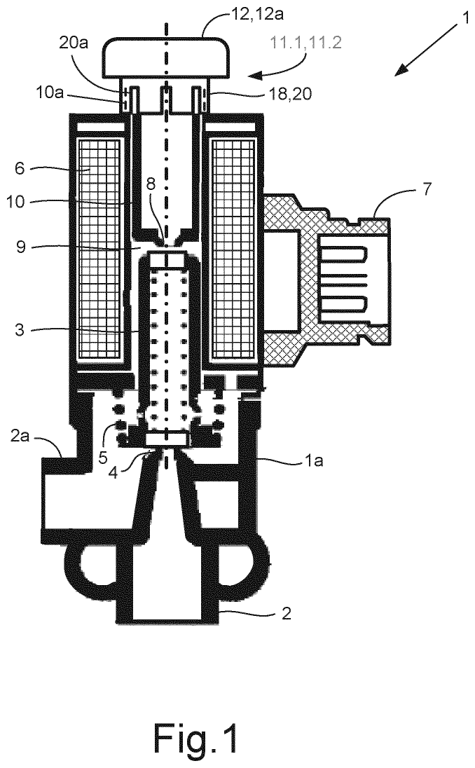

The solenoid valve 1 illustrated in FIG. 1 has a housing 1a with a connection 2 for a supply line to an air container (not illustrated) and with a connection 2a for a working line to a working cylinder (not illustrated).

A magnet armature 3 in the form of a valve body rests sealingly under the action of a compression spring 5 on an inlet 4 for compressed air into the housing 1a, which inlet is closed in the illustrated position. Via a plug-in connection 7 on the housing 1a, an electrical connection to a magnet coil 6 surrounding the magnet armature 3 can be established and an electrical voltage can be applied in a controlled manner to said magnet coil. This is specifically not the case according to FIG. 1, and so the inlet 4 is closed, on the one hand, and an outlet 8 in an outlet tube 10 is open, on the other hand. In this way, compressed air can flow from the working line 2a, through a space 9 between the magnet coil 6 and the magnet armature 3, through the outlet tube 10 and a venting cap 11.1, away into the atmosphere. If electrical voltage is applied in a controlled manner to the magnet coil 6 via the plug-in connection 7, then the magnet armature 3, which is in the form of a valve body, is raised, closes the outlet 8 and opens the inlet 4, with the result that compressed air can flow from the connection 2 for the supply line to the connection 2a for the working line, and from there to a working cylinder (not illustrated).

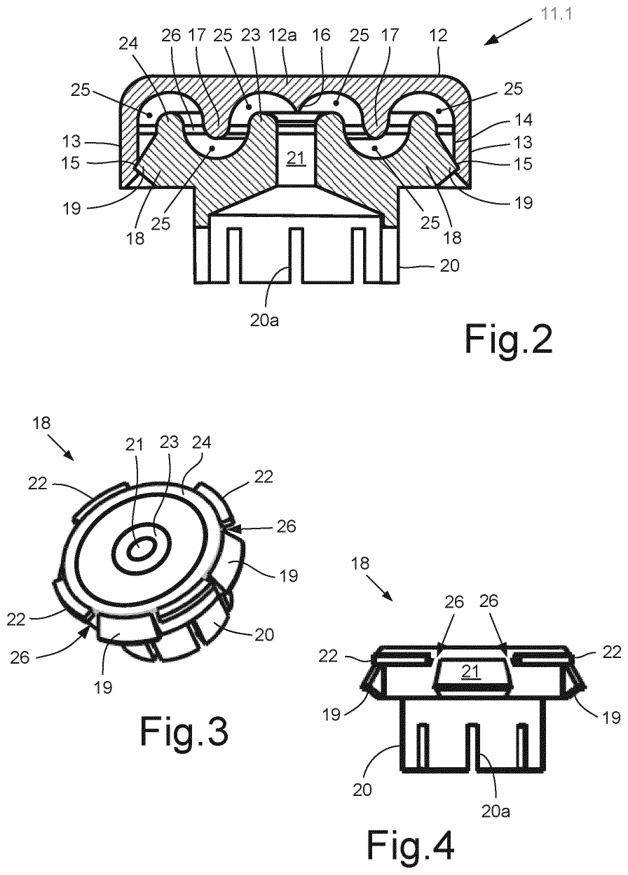

A first embodiment of the venting cap 11.1 as per FIG. 1 is illustrated in FIG. 2 in a schematic longitudinal section. Said venting cap has a sealing element 12 in the form of a pot-shaped cap with a planar base 12a and with an annular rim 13 which extends coaxially with respect to the geometrical longitudinal axis of the venting cap 11.1. The rim 13 has at its radial inner side 14 at least one receiving means 15, preferably six receiving means 15 distributed uniformly over the inner circumference, which serve for receiving an appropriate number of geometrically complementary, radially projecting snap-in contours 19 of a carrier element 18 of the venting cap 11.1.

The snap-in contours 19 interact with the receiving means 15 at the radial inner side 14 of the rim 13 of the sealing element 12 in the manner of an easily assemblable snap-in connection. If only one receiving means 15 is present in the rim 13, preferably an annular groove formed in the radial inner side of the rim 13, into which annular groove the snap-in contours 19 of the carrier element 18 can latch, is involved.

FIGS. 3 and 4 illustrate, as an exemplary embodiment, that, on its outer circumference between in each case two directly adjacent snap-in contours 19, the carrier element 18 has radially projecting centering projections 22, against which the axial rim 13 of the sealing element 12 can be supported radially. If, as a single receiving means 15, the annular groove mentioned is formed in the radial inner side of the rim 13, the projecting centering projections 22 on the carrier element 18 may be dispensed with, because the snap-in contours 19 engaging into such an annular groove at least sufficiently position the sealing element 12 on the carrier element 18.

FIG. 3 moreover shows that the exit openings 26 for the compressed air to be vented are arranged at the carrier element 18 according to a first embodiment between the radially projecting snap-in contours 19 and/or between the radially projecting centering projections 22.

The carrier element 18 moreover has a coaxial, hollow-cylindrical extension 20. The free axial end of the hollow-cylindrical extension 20 is provided with axial slots 20a, which facilitate the fitting of the venting cap 11.1 on the free axial end 10a of the outlet tube 10 of the solenoid valve 1, but still ensure a firm fit of the venting cap 11.1 on the solenoid valve 1.

As FIG. 2 shows, at its section close to the sealing element 12, the carrier element 18 has, radially at the inside, a central axially extending venting path 21 which opens out into a labyrinthine space (sealing structure 25).

Formed centrally above the mouth of the venting path 21 on the inner side 14, facing in the direction of the carrier element 18, of the base 12a of the sealing element 12 is a central axial projection 16 which is surrounded by an annular projection 17 which is concentric with respect thereto and which extends axially toward the carrier element 18. Said annular projection 17 on the sealing element 12 projects into an annular depression which are formed between two annular projections 23, 24 which are formed on the top side, facing toward the sealing element 12, of the carrier element 18. Consequently, an undulating flow path is created for compressed air flowing away through the venting cap 11.1, which flow path can be seen in FIG. 2 as the labyrinthine sealing structure 25 mentioned above. For exiting said labyrinthine sealing structure 25, the compressed air passes via the stated exit openings 26 into the surroundings, where there is no positive pressure, wherein these exit openings 26 are formed here between the carrier element 18 and the rim 13 of the pot-shaped sealing element 12.

The transitions from the central venting path 21 to a first annular axial projection 23 on the carrier element 18 and, from there, to the second annular projection 24 on the carrier element 18 are also rounded, whereby the undulating structures between the sealing element 12 and the carrier element 18, which have to be overcome by compressed air flowing away radially outward, are formed to be particularly favorable in terms of flow.

The undulating labyrinthine sealing structure 25 may also be formed by rectangular or triangular projections 16, 17 on the sealing element 12 and correspondingly geometrically complementary annular axial projections 23, 24 on the carrier element 18 if this appears to be necessary for manufacturing or functional reasons. It is also possible for more than the concentric projections 16, 17; 23, 24 illustrated in FIG. 2 to be provided.

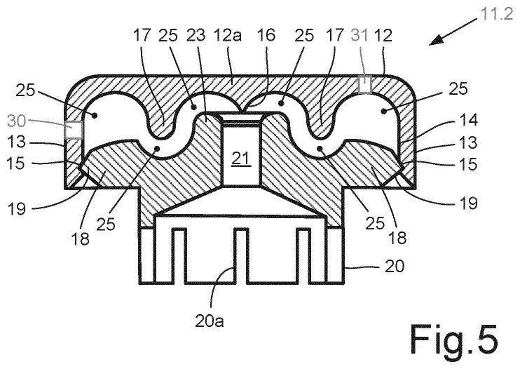

FIG. 5 shows an axial section through a venting cap 11.2 in a second embodiment, which likewise has a cap-shaped sealing element 12 fitted on a carrier element 18. This venting cap 11.2 differs from the venting cap 11.1 as per FIG. 2 in that at least one exit opening 30, 31 is formed at the sealing element 12 and not at the carrier element 18. According to a first variant, at least one exit opening 30 is formed at the rim 13, which extends coaxially with respect to the geometrical longitudinal axis of the venting cap 11.2. Said at least one exit opening 30 extends here from radially inside to radially outside. According to a second variant, likewise illustrated in FIG. 5, at least one exit opening 31 is formed in the region of the radial end of the base 12a of the cap-shaped sealing element 12. Said at least one exit opening 31 extends from axially inside to axially outside. It can be seen in both variants of this second embodiment of a venting cap 11.2 that the carrier element 18 is also of a geometrically simpler form, because a second annular projection 24 on the carrier element 18 is not absolutely necessary for this venting cap 11.2.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

1 Solenoid valve

1a Housing

3 Connection for a supply line from an air container

2a Connection for a working line to a working cylinder

3 Magnet armature in the form of a valve body

4 Inlet

5 Compression spring

6 Magnet coil

7 Plug-in connection

8 Outlet

9 Space

10 Outlet tube

10a End of the outlet tube

11.1 Venting cap (first embodiment)

11.2 Venting cap (second embodiment)

12 Sealing element in the form of a cap

12a Base of the sealing element

13 Axial rim of the sealing element

14 Inner side of the axial rim

15 Receiving means for a snap-in contour

16 Central axial projection on the sealing element, structure

17 Annular projection on the sealing element, structure

18 Carrier element

19 Radially projecting snap-in contour on the carrier element

20 Coaxial, hollow-cylindrical extension on the carrier element

20a Slots in the free end of the cylindrical extension

21 Central venting path in the carrier element

22 Radially projecting centering projections

23 First annular projection on the carrier element, structure

24 Second annular projection on the carrier element, structure

25 Labyrinthine sealing structure

26 Exit openings

30 Exit opening at the rim 13 of the cap-shaped sealing element

31 Exit opening at the base 12a of the cap-shaped sealing element

1. A venting cap for a solenoid valve for compressed-air systems, the venting cap comprising:
a carrier element configured to be arranged on an axial end of an outlet tube of the solenoid valve, and
a sealing element arranged on the carrier element in a region of the axial end of the outlet tube,
wherein the sealing element is in the form of a cap which engages radially and axially over the carrier element and which has a coaxially extending circular rim,
wherein the circular rim has on its inner side, adjacent to a free axial end, at least one receiver for at least one radially outwardly projecting snap-in contour of a geometrically complementary form on the carrier element,
wherein the carrier element has a coaxially arranged hollow-cylindrical extension,
wherein the coaxially arranged hollow-cylindrical extension is configured to be fastened to the axial end of the outlet tube, and
wherein the carrier element has, centrally, a coaxial venting path connected in terms of flow to at least one exit opening via a labyrinthine sealing structure.

2. The venting cap as claimed in claim 1, wherein structures are formed on a side of the base of the sealing element which faces toward the carrier element and on a top side, facing toward the base, of the carrier element and form the labyrinthine sealing structure in an interacting manner.

3. The venting cap as claimed in claim 1, wherein radially projecting centering projections for the rim of the sealing element are formed on the outer circumference of the carrier element between two directly adjacent snap-in contours.

4. The venting cap as claimed in claim 2, wherein the labyrinthine sealing structure of the venting cap is formed by a central axial projection and at least one concentric annular projection on the side of the base of the sealing element which faces toward the carrier element and, on the top side of the carrier element, by at least one concentric annular projection on the carrier element.

5. The venting cap as claimed in claim 4, wherein, as seen in a cross section of the venting cap, undulating structures are formed between the projections on the base of the sealing element and the projections on the top side of the carrier element, the undulating structures forming a labyrinth of the labyrinthine sealing structure.

6. The venting cap as claimed in claim 5, wherein the undulating structures of the labyrinthine sealing structure are provided structurally by free spaces between the projections on the base of the sealing element and the projections on the top side of the carrier element are opened by the compressed air to be vented.

7. The venting cap as claimed in claim 1, wherein the at least one exit opening for the compressed air to be vented are arranged at the carrier element between the radially projecting snap-in contours and/or between the radially projecting centering projections.

8. The venting cap as claimed in claim 1, wherein the at least one exit opening for the compressed air to be vented is formed at an axial rim of the cap-shaped sealing element.

9. The venting cap as claimed in claim 1, wherein the at least one exit opening for the compressed air to be vented is formed radially at the outside at the base of the cap-shaped sealing element.

10. A method, comprising:
using the venting cap as claimed in claim 1 on a solenoid valve in connection with compressed-air braking systems, manual-transmission actuation devices and/or air-spring and axle-lifting systems for vehicles.

11. A motor vehicle having a venting cap, as claimed in claim 1, on a solenoid valve in a compressed-air system in the form of a compressed-air braking system, a manual-transmission actuation device and/or an air-spring and axle-lifting system.
